(19) United States
(12) Patent Application Publication
(10) Pub. No.: US 2013/0089287 A1
(43) Pub. Date: Apr. 11, 2013

(54) Optical Sensor Cable for Use in Measurements in UV Light and for Use During Irradiation Processes

(71) Applicant: Ulrich Glombitza, Bergisch-Gladbach (DE)

(72) Inventor: Ulrich Glombitza, Bergisch-Gladbach (DE)

(21) Appl. No.: 13/635,196

(22) PCT Filed: Mar. 15, 2011
(86) PCT No.: PCT/EP11/01271

§ 371 Date: Dec. 19, 2012

(30) Foreign Application Priority Data
Mar. 16, 2010 (DE) 102010011610

(51) Int. Cl. G02B 6/44; F16L 55/165

(52) U.S. Cl. 385/12; 138/97

(57) ABSTRACT

The invention relates to an optical sensor cable provided in the form of a ribbon cable (1) and to the use of the optical sensor cable for the measurement of light in the UV range and to the use thereof in technical irradiation procedures using UV light. The optical sensor cable provided in the form of a ribbon cable (1) comprises a profiled body (2) having a flat cross-section. Said profiled body has at least one highly transparent sub-region (6) extending centrally and parallel to the axis of the sensor cable. An optical waveguide (8) that can be used for optical measurement methods in the UV wavelength range is embedded in the transparent sub-region (6). The highly transparent sub-region (6) is designed to be optically accessible on a flat face of the profiled body (2). The use of an optical measurement method is directed, for example, at a UV light measurement and/or a temperature measurement during installation and during the curing process in a relining tube (20).

The invention relates to an optical sensor cable designed as a flat ribbon cable which is intended for use in measurements in UV light and for use during UV light irradiation processes.

Optical cables are widely known, though their cross-sections are usually designed circularly (to name an example: DE 92 17 037 U1). A fibre-optic sensor cable which is designed as a flat ribbon cable is known (DE 2600100 A1). Such cable has a different rigidity for both directions of the transverse dimension; it especially has a higher flexibility for bends around an axis of the smaller transverse dimension compared to bends around an axis of the larger transverse dimension.

Another optical sensor cable is described in U.S. Pat. No. 6,459,087 B1. It serves to measure the intensity of an UV emitter with two or more paired fibre-optic cables which are each enclosed by an edged glass filter and which are covered by a common transparent coating. When the sensor cable is used it is positioned alongside the UV emitter wherein the length of the sensor cable corresponds to the length of the UV emitter. The light of the UV emitter to be measured penetrates the transparent coating and the edged glass filters and into the fibre-optic cables where the latter cables have been doped in a way that enables the light transmission to preferably take place in the blue spectral range in the longitudinal direction of the cable.

A method for repairing pipe or channel systems is the so-called pipe lining method (e.g. EP 0712352 B1, EP 1262708 A1, or WO 2006061129). Flexible tube supports made of stainless synthetic and/or glass-fibres which are saturated with reactive resin moulding compound are used. The fitting into a channel is usually performed by installing the tube (liner) either by inversion (plugging in) by means of hydrostatic pressure or air pressure and pulling the tube in by means of a cable winch and subsequently mounting the tube using air or water pressure or a combination of both. There are two methods for hardening the liner to become a solid plastic pipe: artificial ageing by means of hot water or steam, and UV light curing (UVA or LED technology).

The control process for the light curing technique is described in EP 0122 246 A1. The temperature is measured at different points of the string of lights (inner surface of the lining) and the airflow and the modulation rate of the light source are controlled. Another documentation (DE 101 22 565 A1) describes a device which is used for controlling the UV radiation source in combination with IR temperatures. However, pointed temperature sensors are not capable of fully covering the inner surface of the lining.

A permanent monitoring procedure for a lining (reliner tube) in a pipe or channel system is known (DE 102007042546 A1). This procedure employs a fibre-optic sensor which is placed extensively in conjunction with the lining. Using the sensor, one can determine the surface temperature field of the inner surface of the lining as an extensive temperature profile.

With regard to the fibre-optic measuring sensor technology with spatial resolution by means of optical sensor fibres we shall name the Raman measuring method (EP 0 692 705 A1), the temperature measuring using the fibre-optic Brillouin method (DE 199 50 880 C1), or the backscattering measuring of the Rayleigh radiation. One of the most important diagnostic measuring procedures for fibre-optic transmission paths is the “Optical Time Domain Reflectometry” which is abbreviated as OTDR.

The use of UV light coupled in at the cladding side of optical fibres has already been suggested (U.S. Pat. No. 4,418,338). The use of this type of UV light serves to detect fires, which is possible due to the transparent or non-existent coating of the optical fibre.

The task of the invention is to specify a flexurally rigid sleeve for at least one sensor fibre which is capable of being used for optical sensor technology within a short wavelength range wherein UV light (coating side) can be coupled in the sensor fibre for the length of the cable coating which is designed as a flexurally rigid sleeve.

Another part of the task is to use the sensor cable in the monitoring of the setting process of a lining in a pipe or channel system or in monitoring the UV irradiation of sewages contaminated with microorganisms.

The solution for the task can be found in the main claim and in the claims of use. Further and advantageous designs have been formulated in the subsidiary claims.

The core of the invention consists of the special design of an optical cable core and optical cable coating for an optical sensor cable designed as a flat ribbon cable.

The optical cable core comprises an optical waveguide (OWG) which is capable of conducting light of a short wavelength wherein the optical waveguide has a coating which is transparent for light of a short wavelength and which couples in light which is emitted into the coating side, and which transmits the light in the longitudinal direction.

The cable coating is designed with a cross-section of a flat profile body. The profile body has at least one sub-region with a high optical transparency for light of a short wavelength. Two preferred designs of the profile body are being suggested: a first design for which the complete profile body has a high optical transparency for light of a short wavelength, or a second design with a highly transparent sub-region within which the optical waveguide is positioned and a second, coloured sub-region with low optical transparency.

The sub-region with high optical transparency can be fitted with a coating capable of receiving the optical waveguide, wherein the coating itself has a high transparency for light of a short wavelength and the position of the coating in the profile body corresponds to the neutral layer of the profile body. The highly transparent sub-region of the profile body includes the geometrical centre of the profile body and is designed so that it opens like a funnel towards one of the flat sides of the profile body.

The optical media of the optical waveguide, i.e. core, cladding, coating, and secondary coating, the optical media of the transparent coating (if existent) and the optical media of the transparent sub-region of the profile body consist of materials that have each a high optical transparency for light of a wavelength range between 200 nm and 480 nm; they preferably have an additional high optical transparency for light of the spectral lines of a mercury arc lamp in the above wavelength range.

The optical properties marked with the abbreviation “high optical transparency” are to be understood for the purposes of the invention such that the optical media have a low spectral absorption which is combined with the desired property for diffuse scattering where the latter is due to the materials. Transparency is hence defined as the difference of emitted minus penetrating light wherein the penetrating light contains a certain percentage of scattered light.

The term UV light shall, in the following, mean light in a wavelength range of 200 nm to 480 nm, specifically light in a wavelength range of 350 nm to 450 nm. Preferably, the term UV light can be limited to the strong spectral lines of a mercury arc lamp in the specified wavelength range. For this preferred design, special transparency ranges qualify for one of the following Hg lines: Hg line g at 436 nm; Hg line h at 405 nm; Hg line i at 365 nm, or Hg line at 334 nm.

The (first) optical waveguide according to the invention is an optical fibre which is designed so that the light of the specified wavelength range can penetrate into the optical fibre on the coated side and that the light is transmitted along the optical fibre. For use with very short wavelengths of a UV range below 315 nm please note that a usual quartz fibre is not exactly suitable. A solarisation-resistant quartz glass-fibre (such as commercially available from Leonie company under the label of “j-Ultrasol-Fiber”) shall be used for the specified wavelength range.

The optical waveguide, the transparent sub-region and, the transparent coating, if existing, are designed for the full length of the profile body. The transparent sub-region can be mirrored on the inner surface.

The coating inside the profile body (as a possible further embodiment) is designed as tube made of synthetic material with a high transparency for light of a short wavelength, especially for a wavelength range between 200 nm and 480 nm. The tube may be made of polyamide wherein it e.g. has a diameter of 1.6 mm and receives the optical waveguide loosely. The structure of the profile body made of a first synthetic material and an inside coating made of a second (different) synthetic material has the advantage that the profile body, the coating (tube), and the optical fibre can be separated in an optimum way for plug packaging purposes.

The optical waveguide comprises a core of purified quartz, a cladding of quartz contaminated with fluorine and a coating of a transparent synthetic material wherein this optical waveguide (as another advantageous embodiment) is fitted with a secondary coating in the form a layer of synthetic material with a high transparency for light of a short wavelength, especially for wavelengths between 200 nm and 480 nm. Such optical waveguides usually have a core refractive index of n=1.46 and a refractive index less than 1.46 for the cladding. The coating and the secondary coating are usually made of one or two acrylate varieties.

Typical dimensions of the optical fibre: Core diameter=110 μm, cladding thickness=140 μm, coating thickness=250 μm, total diameter incl. the secondary coating (if existent)=900 μm, secondary coating material: PVC wherein its polymer composition and possible additives are adapted to the specified optical properties. Besides, customary optical waveguides based on quartz can be used as well; such optical waveguides have the following dimensions: core diameter=200 μm, cladding thickness=220 μm, coating thickness=250 μm. Optical fibres based on quartz are available on the market e.g. by the Leoni company (Austria) which distributes such fibres under the label “pursilica-Faser”.

The transparent sub-region with the embedded optical waveguide is designed so that the transparent sub-region is open to both flat sides of the profile body. Two transparent sub-regions are designed so that they open like a funnel towards on flat side of the profile body each. The profile body is completely made of PVC or polycarbonate; the non-transparent sections of the profile body consist of coloured PVC or of polycarbonate as well.

In order to reduce the reflection losses antireflex coatings can be used optionally on the refracting media.

The profile body material is solid enough to allow the clamping of optical plugs at the ends of the profile bodies.

The profile body shall have a flexural rigidity that makes sure that, when bending the profile body by 180°, the ultimate strength of the optical waveguide (s) in the profile body is not exceeded.

The profile body may be fitted with a protective cladding made of synthetic material. The protective cladding shall be designed optically transparent for the optically transparent sub-regions.

The optical waveguide (s) shall be embedded captive in the profile body. According to the invention, the optical waveguide based on quartz is positioned in the highly transparent sub-region. The second optical waveguide is positioned outside the sub-region inside which the optical waveguide based on quartz is located. This sub-region is preferably coloured, hence non-transparent. A position of the second optical waveguide near reinforcing elements in the profile body has the advantage that the reinforcing elements are considered for plug packaging purposes as well and hence represents direct cable relief elements for the plugs.

Both optical waveguides can be installed loose (as an empty tube structure), possibly even using padding or a slip agent. Beside the direct, loose embedding in the transparent section one can also envisage a transparent coating in the form of a tube to be fitted in the transparent section; the optical waveguide will then be installed in the tube.

In order to manufacture a sensor cable according to the invention, the following steps shall be explained in short:
Installation of a quartz optical waveguide as specified above;
In case of using an optical waveguide with secondary coating as “thickening”: Manufacturing of the secondary coating on the quartz optical waveguide in the course of an extrusion process using transparent plastic;
in case of using a special sleeve: Pulling the optical waveguide into a tube (e.g. made of polyamide and e.g. with a diameter of 1.6 mm) as a sleeve,
Manufacturing a profile body (preferably made of PVC or polycarbonate) with approximate dimensions of 6 mm in thickness and 12 mm in width, by extrusion with the optical waveguide (and/or tube, if existent) in the centre of the profile body.
the material of the profile body may consist of two different synthetic materials in terms of substance: a first highly transparent synthetic material for the high transparency sub-region, and a coloured synthetic material (e.g. in a dark colour).

The application of optical measurement technology envisages a UV light measurement (preferably within the UV spectrum and transparency in the UV range) with the first optical waveguide (hereinafter abbreviated as “OWG”) as well as a fibre-optic temperature measurement with spatial resolution using the second OWG. Fields of application will be discussed later on.

The coupling and the transmission of UV light in/through OWGs has certain limits, however. The small geometric dimensions of an OWG based on quartz limit the interaction surface of the OWG which is penetrated by UV light. For a large-core fibre with an example core diameter of 0.6 mm and a UV illumination length for the OWG by a UV string of lights of approx. 1 m, the interaction surface is only 600 mm². According to the invention, the interaction surface can be increased by thickening the optical waveguide and by using the cladding made of highly transparent synthetic material in the profile body. The UV light is being scattered in the optical media of the cladding and the thickening so that not only light which incides perpendicular to the optical waveguide but also UV light that incides (due to the scattering) angularly.

In order to increase the flexural rigidity of the sensor cable enforcing or sheathing elements may be installed in the profile body in the longitudinal direction (steel wire, plastic fibre clusters, etc.) which essentially extend alongside the cable axis. Stiffening elements can also be installed in the transverse direction of the profile body. When the sensor cable is being creased the sheathing elements will avoid that the minimum radius of the optical waveguide (its rupture limit) is not exceeded. The sheathing elements will absorb tractions during the installation of the sensor cable and will also help to reduce the longitudinal elongation of the sensor cable.

As already described in short, a second optical waveguide may be installed in the cable core in addition to the first optical waveguide. The second optical waveguide is capable of being used for fibre-optic temperature measurement procedures with spatial resolution wherein this one is a standard fibre (usually with an optical fibre core doped with germanium). The temperature-dependent Raman radiation which is later evaluated for fibre-optic temperature measurement procedures with spatial resolution is generated inside of the optical waveguide. This second optical waveguide can also be fitted with tractive elements for traction relief. The second optical waveguide should preferably be positioned outside (asymmetrical) of the sub-region where the first optical waveguide is located, but in the centre level as the first optical waveguide.

The sensor cable can be used for different purposes.

A special use of the sensor cable might be the use for the repairing technology for channels or pipes. For this purpose the sensor cable is put up flat on a surface in the longitudinal direction of a relining tube. The sensor should preferably positioned on the relining tube in a way that locates the sensor cable in the vertex area (12 AM position) of an old pipe or channel to repair.

For this UV light curing method the transmission characteristics of the relining tube material changed. The UV light is being absorbed in the tube material and causes an exothermic reaction inside which initiates the curing process. With the UV light exposure duration increasing, the material hardens and becomes more and more transparent. The spectral distribution of the UV light significantly influences the exothermic reaction in the tube material and hence affects the curing process. The sensor cable shall therefore be used in the measurement of the UV absorption resp. the UV intensity. Using the suggested measuring method, parameters are being determined while assessing the state of hardening.

Since reliner tubes which are saturated with resin and which shall be light cured can be activated by UV light, the reliner tubes are wrapped in protective film impermeable for UV light to prevent the tubes from being activated prematurely by early light exposure. The sensor must hence be installed under the protective film impermeable for UV light, on the surface of the relining tube. For the above purpose, relining tube and sensor cable shall be up to 300 m in length.

The monitoring method which is applied during the hardening process of a resin (which was used to saturate a tube liner) which can be activated using light of a short wavelength, e.g. the light of a mercury arc lamp, may include the following process steps:
Insertion of the lining in the form of a relining tube, in conjunction with the sensor cable, into a system of pipes or channels,
Pulling a UV light source through the pipe and emitting UV light from the light source onto the relining tube, thereby hardening the resin,
measuring and monitoring the time curve of the UV spectrum and/or the UV transmission and/or
measuring and monitoring the time curve of the temperature by means of the sensor cable, in the form of a temperature measurement with spatial resolution using a fibre-optic temperature sensor technology with spatial resolution.

The optical measurements will provide process parameters for the hardening process wherein the parameters can be logged in dependence of the advance and the speed of a UV string of lights in the old pipe.

The known flat ribbon cable structures are designed for durability, especially for the fibre-optics. Different requirements arise for the repair of channels. The sensor cable serves to measure the temperature and/or the UV light. The sensor cable will not be required any longer as soon as the repair work is done. Hence the sensor cable can be designed as a disposable one. The requirements with regard to bend, pressure, and traction should, however, be even higher since the pressure forces on the sensor cable play an important role during manufacturing, transport, and installation. The fibre will slacken off as soon as the relining tube has been pulled through. It is important for the cable structure to ensure that the optical waveguide (s) cannot be destroyed by external forces (break). This is why the design (and the thickness) of the profile body is of essential importance.

The proposed flat ribbon structure allows, as opposed to a round cable structure, an optimum position on the relining tube during the manufacturing process at the factory. The rectilinear position prevents the structure from turning (torsion) in the longitudinal direction of the sensor and hence reduces the risk of breakage. Moreover, the flat ribbon structure ensures that the UV window is directed towards the UV light source.

When measuring the UV light, however, (in contrary to measuring the temperature) no measurement can be performed with spatial resolution. Due to the positioning of the sensors, the transmission of the liner during the hardening process, and/or the spectral distribution of the UV light are measured at the location of the reliner tube at which the UV light source is situated (and impacts). During the repair measures the UV source (resp. the UV string of lights) will be drawn along the relining tube. The current position of the string of lights is hence known during the UV curing. The measured variables of the optic sensor cable can hence be allocated (indirectly) to the location along the reliner tube.

Details of the sensor cable for special use with a relining tube:
Optically transparent window for measuring the UV light The sensor cable can be bent (creased) by 180° without risking to break the optical waveguide (breakage protection)
Avoid turning motions (torsion) with the optical waveguide when embedding the optical waveguide in a rectilinear way in the relining tube on the tube surface at the factory
Enhanced mechanical protection of the sensor cable against external pressure and traction
Compact structure in the circumferential direction of the relining tube
An appropriate protective casket (silicon casket as protection for optical waveguide plugs) can be used for packaged UV measurement cables.

The square-shaped flat ribbon structure (relation width/height−factor 2) of the sensor cable allows for a compact structure in the circumferential direction of the relining tube.

Beside the use previously mentioned a second use of the sensor cable shall be specified.

The sensor cable can be used for non-destructive material testing purposes or for monitoring irradiation procedures in the UV range. This is e.g. applicable for testing medication for their photostability, or for disinfecting drinking water and sewages by means of UV light. For the latter use irradiation is applied in order to kill germs, bacteria and fungi.

The invention is explained in detail in the Figures wherein these show the following:

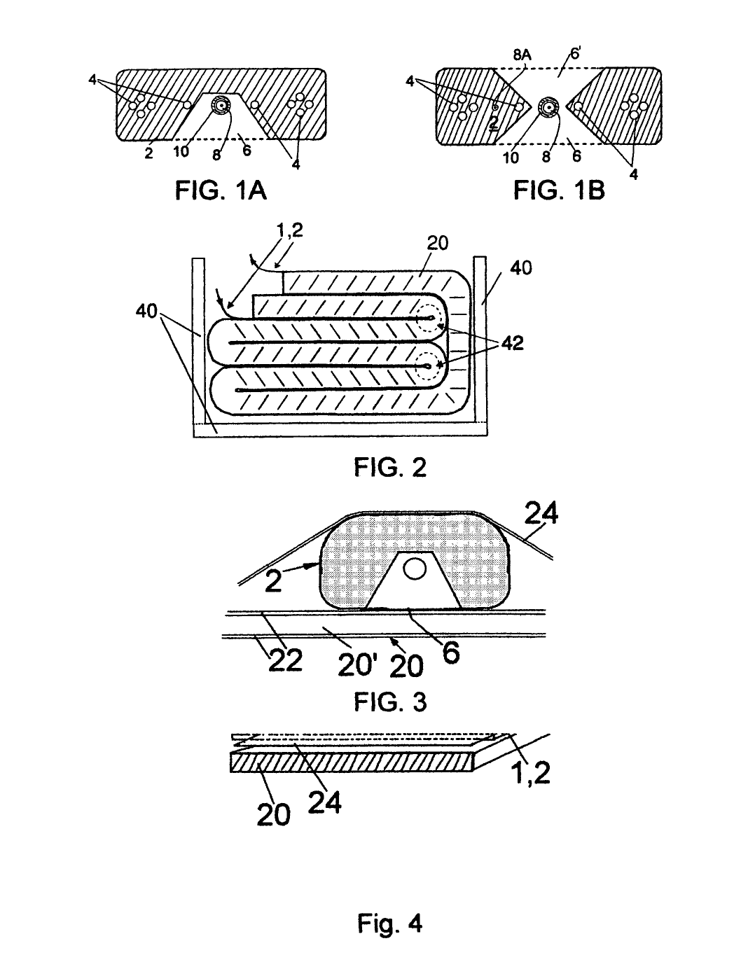

FIGS. 1A and 1B: Cross-sections of two sensor cable embodiments

FIG. 2: Tube liner with sensor cable in transport situation,

FIG. 3: Cross-section of a sensor cable on a relining tube, and

FIG. 4: Installation situation concerning the manufacturing; shows a sensor cable on a relining tube with protective film impermeable for UV light.

The Figures show the details of the optical sensor cable 1 which is designed as a flat ribbon cable. It comprises a profile body 2 with a flat cross-section; the profile body 2 has at least one high transparency sub-region 6 which extends alongside the axis of the sensor cable and serves to receive optical waveguide 8, 8A. The high transparency sub-region 6 forms an optical window at the side of the flat side of the profile body.

The first optical waveguide 8 conducts UV light and is coated with an optically transparent coating. A second optical waveguide 8A is a standard fibre which is suitable for fibre-optical temperature measuring with spatial resolution (generally with a fibre core doped with germanium). Preferably, as shown in FIG. 1B, the second optical waveguide 8A is located asymmetrically outside of the area where the first optical waveguide is located.

Multiple elongated stiffening or sheathing elements 4 are placed inside of the profile body 2. Stiffening elements can also be installed in the transverse direction of the profile body (not illustrated in the figures, however).

The cross-section of the profile body 2 is of rectangular shape and has a greater extension alongside the support (in width) and a lesser extension perpendicular (in thickness) to that. The profile body can have usual dimensions of approx. 5 mm to 15 mm in width and usual dimensions of 3 mm to 6 mm in thickness (narrower extension). The first optical waveguide 8 is located in the neutral layer of the profile body 2 with regard to the bending stress. hence it is located in the half thickness of the profile body 2.

Due to this flat ribbon cable design the sensor cable has different flexural rigidity properties in both layers which are perpendicular to the cable axis. It essentially important that the flexural rigidity of the profile body around the axis, which is parallel to the transverse elongation and perpendicular to the longitudinal direction of the profile body, is high enough to ensure that the profile body, for the usual stress that exists when placing a relining tube and even when the preparation works including the manufacturing process are performed, does not bend more than the value necessary to exceed the ultimate strength of the optical waveguide placed inside the profile body. Modern optical waveguides have a high ultimate strength with regard to bending.

The sensor fibre (the first optical waveguide) is in the sub-region 6 which is transparent to UV light and is enclosed by a transparent coating.

FIGS. 1A and 1B show embodiment examples of profile body with transparent sub-regions 6, 6′ which open like a funnel to one flat side of the profile body each. Moreover, FIG. 1B shows a possible arrangement with optical waveguide 8 based on quartz and a temperature sensor fibre 8A.

The loose arrangement of the sensor fibre 8 based on quartz within a transparent tube which scatters UV light (coating 10) allows for another advantage: more UV light can be coupled in the fibre core.

FIG. 2 shows a relining tube 20 with a sensor cable 1, 2 in a state where the relining tube 20 is transported to the installation site in a transport box 40. This Figure illustrates the problem of bending and pressure stress on the relining tube during the manufacturing process (packaging) at the factory and during transport. The consolidated relining tube is being deposited in transport boxes 40 (meander-like) directly from the manufacturing belt. When embedding the sensor cable (e.g. in 12 AM position, this corresponds to the vertex area in the old pipe of the channel to be repaired) on the relining tube and subsequently depositing it in the transport box, the outer tube sections have to bear strong bending stress in the reverse points 42 (180° turn) and also have high pressure stress due to the high weight of the relining tube (up to a few tons of weight). When bending the sensor cable 2, the flexural rigidity of the optical waveguide(s) 8 placed inside the profile body will not be exceeded, even though both outer coatings of the sensor cable will come into contact due to the 180° turn. A prerequisite for the mechanical protection of the optical waveguide is the embedding of the optical waveguide in the sensor cable, i.e. in the neutral layer of the profile body with regard to the bending stress. Embedded in the neutral layer of the profile body, the optical waveguide will only have to bear little to no traction and elongation stress when bent. Bends will only occur in brief periods, i.e. in the time from packaging into a transport to the withdrawal from the transport box shortly before the installation.

FIG. 3 shows a cross-section of a sensor cable which is placed flat on the surface of a relining tube 20. The tube layer 20′ consists of glass-fibre reinforced, light curable plastic (resin) with a thickness depending on the relining tube diameter each. The thickness may be up to 10 mm. The glass-fibre reinforced synthetic resin layer is fitted with a cover film 22 on both sides. When fastening the sensor cable on the relining tube, the sensor cable is fitted between the relining tube (directly on its surface) and the UV protective film 24. This is why the protective film 24 impermeable to UV light is placed above the fitted sensor cable 1, 2. In an installation situation for the purpose of repairing a defective sewer, a relining tube is installed together with the sensor cable. For this installation, one would preferably proceed to place the sensor cable in the highest position possible, i.e. 12 AM, in the old pipe.

FIG. 4 shows a drawing of the installation situation during the manufacturing of a relining tube 20 with a sensor cable 1, 2 fitted onto the surface of a relining tube 20 and below a UV protective film 24. This is the situation before inserting the fibre tube into a defective sewage pipe and before inflating the tube by means of pressurised air in order to make the tube fit perfectly tight to the inner surface of the pipe.

### REFERENCE NUMERALS

1 Sensor cable

2 Cable sheathing, profile body

4 Sheathing elements

6, 6′ Transparent sub-regions

8 First optical waveguide (conducts UV light)

8A Second optical waveguide

10 Transparent coating, tube

20 Relining tube

20′ GRP body (tube location)

22 Cover film(s) for the relining tube

24 UV protective film

40 Transport box

42 Bending areas

R′ Bending radius relining tube

1. Optical sensor cable designed as a flat ribbon cable which consists of an optical cable core
and a cable sheathing as follows:
the optical cable core:
it comprises an optical waveguide (8) which is capable of conducting light of a short wavelength wherein the optical waveguide (8) has a coating which is transparent for light of a short wavelength and which couples in light which is emitted into the skin of the waveguide, and which transmits the light in the longitudinal direction;
the cable sheathing:
it is designed with a cross-section of a flat profile body (2);
the profile body (2) consists of a material which is transparent for light of a short wavelength; the optical waveguide is installed in this material wherein the position of the optical waveguide (8) in the profile body (2) corresponds to the neutral layer of the profile body (2),
wherein the optical media of the optical waveguide (8) and of the profile body (2) have been as chosen materials which allow for an optical transparency for light of a wavelength between 200 nm and 480 nm each.

2.-15. (canceled)

16. Optical sensor cable designed as a flat ribbon cable, according to claim 1, characterised in that the profile body (2) has at least one sub-region (6, 6′) which is optically transparent for light of a wavelength between 200 nm and 480 nm and that this one transparent sub-region (6, 6′) extends at least to one of the flat sides of the profile body (2), and that the profile body (2) has at least one sub-region with a low optical transparency for light of a wavelength between 200 nm and 480 nm.

17. Optical sensor cable designed as a flat ribbon cable, according to claim 1, characterised in that the profile body (2) is made of polyvinyl chloride or polycarbonate.

18. Optical sensor cable designed as a flat ribbon cable, according to claim 1, characterised in that sub-regions of the profile body (2) with low optical transparency are made of coloured polyvinyl chloride or coloured polycarbonate.

19. Optical sensor cable designed as a flat ribbon cable according to claim 1, characterised in that there is a jacket (10) installed in at least one transparent sub-region (6, 6′), capable of receiving the optical waveguide (8), wherein the jacket (10) itself is optically transparent for light of a short wavelength and the position of the jacket (10) in the profile body (2) corresponds to the neutral layer of the profile body (2).

20. Optical sensor cable designed as a flat ribbon cable according to claim 1, characterised in that the optical waveguide (8) has a core made of quartz, a cladding made of quartz doped with fluorine, and a coating made of plastic.

21. Optical sensor cable designed as a flat ribbon cable according to claim 6, characterised in that the optical waveguide (8) is fitted with a secondary coating in the form of a plastic layer with a high transparency for light of a wavelength between 200 nm and 480 nm.

22. Optical sensor cable designed as a flat ribbon cable according to claim 1, characterised in that the optical media of the optical waveguide (8), the optical media of the transparent jacket (10), and the optical media of at least one transparent sub-region (6, 6′) of the profile body (2) consist of materials which allow for an optical transparency for light of a wavelength between 350 nm and 420 nm.

23. Optical sensor cable designed as a flat ribbon cable according to claim 1, characterised in that elongated reinforcing elements (4) are embedded into the profile body (2) for the whole length of the sensor cable (1).

24. Optical sensor cable designed as a flat ribbon cable according to claim 1, characterised in that a second optical waveguide (8A) is installed beside the first optical waveguide (8) in the cable core; the second optical waveguide is configured as a Raman temperature sensor in context of a fibre-optic measuring procedure with spatial resolution.

25. Optical sensor cable designed as a flat ribbon cable according to claim 1, characterised in that the profile body (2) has a flexural rigidity which prevents the ultimate strength of the optical waveguide(s) (8, 8A), which are installed in the profile body (2), from being exceeded in case of bending the profile body by 180° or more.

26. A method for relining a tube which includes placing an optical sensor cable according to claim 1 designed as a flat ribbon cable fitted flat on a surface of a lining hose (20), and placing a protective film (24) that is impermeable to light of a wavelength between 200 nm and 480 nm over the sensor cable (1) fitted on the surface of the lining hose (20).

27. A method for optically measuring process parameters of a curing process of a lining hose (20) impregnated with curable resin which can be activated by light of a wavelength between 200 nm and 480 nm, comprising measuring the process parameters with an optical sensor cable according to claim 1.

28. A method for optically measuring process parameters of a curing process of a lining hose (20) according to claim 27, wherein the sensor cable (1) is used to measure a change of the transparency over time during the curing process of the lining hose (20) impregnated with curable resin.

29. A method for curing a lining hose (20) impregnated with curable resin which can be activated by light of a wavelength between 200 nm and 480 nm comprising:
activating the lining hose (20) with light of a wavelength between 200 nm and 480 nm; and
measuring temperature during the curing process with spatial resolution with an optical sensor cable with properties according to claim 24.

30. A method of disinfecting liquids contaminated with germs comprising:
irradiating a contaminated liquid with light of a wavelength between 200 nm and 480 nm and monitoring the irradiation processes with an optical sensor cable with properties according to claim 1.
